(19) United States
(12) Patent Application Publication
(10) Pub. No.: US 2005/0288930 A1
(43) Pub. Date: Dec. 29, 2005

(54) Computer voice recognition apparatus and method

(75) Inventors: Jack B. Shaw, Johnstown, PA (US); David A. Smith, Johnstown, PA (US); Robert E. Shaw JR., Johnstown, PA (US)

Correspondence Address: BANNER & WITCOFF, 1001 G STREET N W, SUITE 1100, WASHINGTON, DC, 20001, US

(73) Assignee: Vaastek, Inc., Johnstown, PA (US)

(21) Appl. No.: 11/148,443

(22) Filed: Jun. 9, 2005

Related U.S. Application Data
(60) Provisional application No. 60/578,078, filed on Jun. 9, 2004.

(51) Int. Cl. G10L 15/18

(52) U.S. Cl. 704/257

(57) ABSTRACT

The present invention relates to a system and method for speech recognition that receives speech input and converts the speech input to data. A database is accessed to determine stored data corresponding to the speech input data. The stored data is associated with desired output data. The output data is output to a user as speech output. The speech output data may be in the same voice as the user to enhance comprehension and clarity. The present invention may be used in sorting mail in which a street address or post office box number is spoken into the system and the system provides desired information in the form of speech. The desired information may include carrier route number, mail-forwarding information, mail hold information or fee payment information but is not so limited. The present invention may also be used to provide excerpts of written material to a user on command, such as a desired chapter/verse of the Bible.

This application claims the benefit of U.S. Provisional Application Ser. No. 60/578,078, filed Jun. 9, 2004, incorporated herein in its entirety.

### FIELD OF THE INVENTION

The present invention relates to an apparatus and method for computer voice-recognition and in particular, computer voice recognition for user voice feedback systems.

### BACKGROUND OF THE INVENTION

Computer voice recognition and dictation systems have been recently used in the art for limited purposes. In prior art systems, computers are adapted to recognize spoken words of a particular user and to translate the spoken words via speech-recognition software into written words in the form of text. The written text information is then output on a computer monitor in a word processing program. The document thus generated may then be printed or stored in computer memory. Thus, many computer speech recognition systems have been used exclusively as a dictation device in which a user may type words into a computer by speaking the words rather than having to manually type in words on a computer keyboard.

Computer voice recognition and dictation systems have been most commonly applied in the medical and legal fields in which information is dictated into a microphone by a user in the form of spoken words. The computer contains speech-recognition software that recognizes the spoken words of the user and produces the written text form of the spoken words on a computer screen. In the medical field, physicians dictate patient information such as a patient history, in-patient progress or findings on a physical examination of the patient into the microphone of a computer and the computer generates the dictated patient information in written form on the computer monitor. In the legal setting, attorneys and paralegals may similarly dictate any information that would ordinarily be typed into the computer. This might include briefs, letters, or e-mail. The computer performs the “typing” and produces a written document containing a written transcript of the dictated words.

In addition to dictation, home security systems, climate control, and other systems in the home have been controlled through the use of computer voice recognition systems. For example, if a user wishes to turn down the heat in the house to a specified level, the user would issue a verbal command into a microphone on a computer to turn the heat down to the specified level. The computer voice recognition system through speech-recognition software would process the received verbal command and respond to the verbal command by turning down the heat as requested.

Such voice recognition systems have provided users with the ability to produce written documents and perform household regulatory tasks such as temperature control in a “hands-free” manner. Dictation and control of the home is accomplished through a strictly one-way process in which the computer receives verbal commands from a user and responds by performing the requested task. However, such systems do not provide verbal feedback to the user as needed. For example, in these systems, a user cannot retrieve information from a computer database response to a verbal request. Nor can a user receive requested data from a computer in audio form. Furthermore, there is no computer voice-recognition system in which the computer provides audio information responsive to a user's verbal request in a format that would ensure easy comprehension by the user.

In prior art systems, users with unique manners of speech, regional accents, dialects, foreign accents, speech impediments or the like have faced difficulty in voice recognition. Although some prior art systems have attempted to “train” a voice recognition system to recognize different speech patterns and sounds, there have been no systems to ensure that the user understands any speech generated by the system. Rather, prior art systems that produce speech do so in a computer generated voice. Hence a user who is unfamiliar with the speech pattern provided by the computer generated speech would not understand the pronunciation provided by the computer. This results in loss of efficiency of the process.

Such a system is disclosed in U.S. Pat. No. 6,581,782 (Reed) which discloses a system and method for sorting mail items in which an addressee's name is wirelessly transmitted to a computer workstation. A data record corresponding to the addressee's name is returned to the user from a database on a computer display or via a speaker in a headset. However, these systems produce computer synthesized speech which may be incomprehensible to the mail sorter. This problem is compounded if the mail sorter speaks in a unique way (e.g., local dialects) such that standard computer “speech” might be hard to understand. In addition, the prior art systems suffer from prohibitive costs because the use of synthesized speech is expensive.

Also, the prior art systems are unable to accurately identify all necessary speech input. This is due in part to the fact that the prior art systems are non-selective in the variation of voice input. Accuracy is thus impaired in the prior art systems.

Thus, there exists a need in the art for a method and system for automating a procedure in which a user may access computer information in a “hands-free” manner while ensuring the integrity and comprehensibility of the returned information from the system.

### SUMMARY OF THE INVENTION

The present invention relates to a voice recognition system and method in which a user may input voice information into an input device, for example, a voice user interface (VUI). The input voice information is converted from speech to data using speech recognition software, for example, in a Speech Recognition Engine (SRE). The data may further be stored in a database. The input voice information is compared to stored data in the database. Matching data obtained from the database may be associated with desired information or data in the database. The desired information or data is output in the form of speech, for example, by a data output engine. The output speech data is output to the user, for example, through a Voice User Interface (VUI). The output speech data may be in the same voice as the input voice data to optimize clarity and comprehension.

In one example of the present invention, a post office clerk may speak a street address or post office box identification information into the system. The system converts the input speech data into non-speech data and compares the input non-speech data with data stored in a database. Matching data found in the database may be associated with desired output data. The output data thus obtained from the database is output as speech information to the post office clerk. The present invention in this example is particularly useful in providing information pertaining to routing or sorting of the mail such as, but not limited to, carrier route information or post office box information. The present invention is also useful in providing speech output corresponding to desired written material.

The present invention relates to a method and system for voice recognition comprising converting received voice input into first data, converting second data into a speech signal, said second data being associated with said first data, and outputting said speech signal as a voice output. The voice output may be in the same voice as the voice input. The voice input may comprise a word, the word being assigned to an associated phoneme or restricted by a predetermined grammar. The first data may comprise a street address or a post office box number and the second data may comprise a carrier route number corresponding. The first data may also comprise a city, a name of a state, or a zip code.

In another embodiment of the present invention, a method for voice-recognition is provided in which voice input is received from a user and parsed into phonemes. The phonemes may be stored in a database. A second voice input may be received from the user and converted into data. Data corresponding to the converted data is located in memory and output as speech. The output speech may be assembled from phonemes stored in the database as voice output.

The user may input predetermined text or a street address or post office box number, for example. The system may output destination information corresponding to a street address (or post office box). The output information may be in the form of speech and may be in the user's voice.

### BRIEF DESCRIPTION OF THE DRAWINGS

FIG. 1 is a block diagram illustrating an example of the present invention.

FIG. 2A illustrates recognition accuracy of voice recognition as a function of the number of words.

FIG. 2B illustrates recognition accuracy of voice recognition as a function of the number of users.

FIG. 3 illustrates an example of the operation of the present invention.

FIG. 4 illustrates enrollment in the system of the present invention.

FIG. 5 illustrates an example of the system of the present invention in mail sorting.

### DETAILED DESCRIPTION

The present invention provides a system and method for providing information to a user in a “hands-free” manner. In many situations, a user may require information expeditiously while the user is otherwise indisposed. For example, if a user is engaged in an activity that requires his continuous attention, the user may be unable to suspend that activity in order to request the needed information. For instance, if using a computer, the user may not wish to suspend the activity to type in commands on a computer keyboard. Doing so would be time-consuming and could result in errors in the primary activity. Alternatively, a user may be performing an activity in which he requires reminders of certain issues or facts pertaining to the activity at various specified times throughout the performance of the activity. If the user cannot receive these issues or facts pertaining to the activity in an efficient manner, the activity may be adversely impacted causing costly delays or errors. Thus, the present invention provides a computer system in which a user may efficiently obtain the needed information without the need for the user to divert his attention or suspend his present activity.

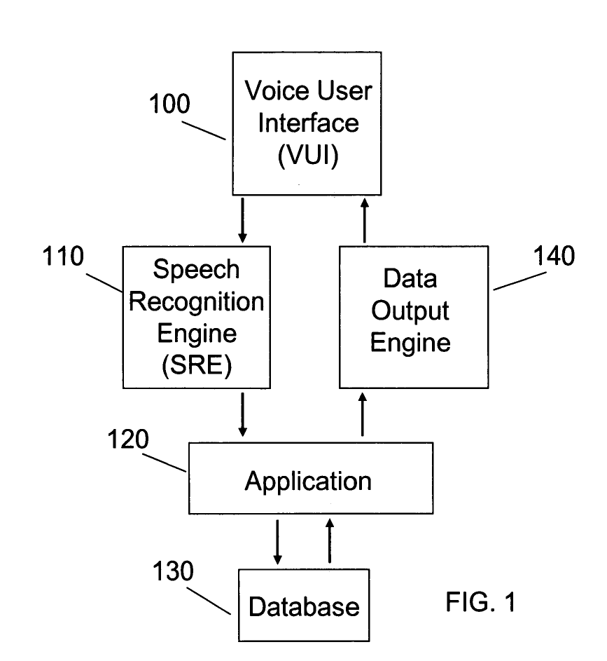

FIG. 1 illustrates an example of the present invention. Voice User Interface (VUI) 100 is the interface between the user and the computer system for voice recognition. VUI 100 may include a headset with a microphone in which the user may speak into the microphone or listen to output from the computer through the earpiece of the headset. Alternatively, the user may listen to output from the computer through speakers. The headset may include only one earpiece so that the user may be able to clearly hear other sounds. In this way, safety and efficiency may be optimized. The VUI 100 may be a mobile unit for receiving voice input from the user and transmitting signals wirelessly to a base station or a server in a wireless LAN. Further, multiple users may be transmitting signals simultaneously.

A Speech Recognition Engine (SRE) 110 receives the signal from the VUI 100. The SRE 110 may be located on a server, for example. Alternatively, the SRE 110 may be located at the mobile client. The SRE 110 receives speech input from the VUI 100 and processes the information in accordance with the application 120. The present invention provides a pairing of SRE 110 and application 120 such that the functioning of the application 120 with SRE 110 is optimized.

Upon receiving the speech input, the SRE 110 creates an acoustic file where the signal may be further optimized through noise reduction and filtering such that ambient noise may be reduced or eliminated. The speech input is converted to phonemes (i.e., speech sounds perceived to be single distinctive sounds). This conversion may be accomplished, for example, through application of a probabilistic function in which the system may use statistical modeling to determine the most likely phoneme based on a previous phoneme. The Markov model is one example of a probabilistic function that may be used in determining phonemes. A word is thus determined which in turn enables the determination of a phrase.

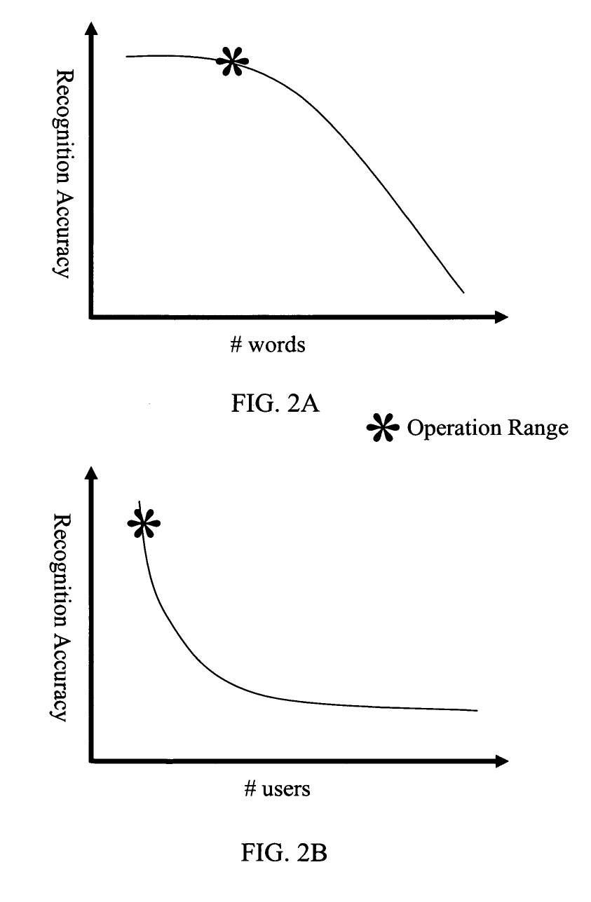

If the number of phonemes is limited to certain select words or phrases or if the number of users is limited, phoneme determination is simplified and optimized. This results in heightened accuracy and efficiency in speech recognition. FIG. 2A illustrates a graph demonstrating that as the number of words (or phrases) increases, the recognition accuracy of the SRE 110 decreases. Limiting the number of words keeps the system operating in an optimal range such that recognition accuracy is maintained. There are many ways to limit the number of words. For example, grammar may be limited or controlled which may in turn control the number of words. Also, the number of words may be limited by assigning relationships between words and phonemes.

Likewise, FIG. 2B illustrates a graph demonstrating that as the number of different users increases, recognition accuracy decreases. One potential reason for the drop off of recognition accuracy may be that different users may produce phonemes in different ways that might be confusing to a computer voice-recognition system. Therefore, limiting the number of users would help to maintain a high level of recognition accuracy.

The application 120 receives properties of the input speech through the SRE 110. These properties might be grammar settings based on changes in the conversation. For example, the grammar settings may change depending on the part of the conversation such that when completing one part of the conversation and starting a new part of the conversation, a new grammar pertinent to the new part of the conversation may be loaded. Another example is during a logon sequence in which the user logs onto the system. In this case, a user name, for example, may be loaded dynamically based on the currently stored profiles.

Data lookup is performed in the database 130 based on the received information as processed by the application 120. The system may further be optimized by limiting the language set that the system returns. If the data stored is limited, speed and accuracy of the system are enhanced.

Data from the database 130 is returned based on matching the input information with the desired output. Thus, based on the verbal input of the user and received through the SRE 110, corresponding data is output from the database 130, processed by the application 120 and converted into speech by the data output engine 140. The data output engine 140 returns the speech output to the VUI 100 which is output to the user. Output data may be returned to the user via a speaker or a headset, either of which may be wireless to enhance mobility of the user.

The audible output data provided to the user may be provided in the voice of the user. In this way, users who may be unfamiliar with the standard computer generated speech will be able to understand the audible output. For example, a user with a regional accent, such as an accent from the Southern states or from a New England state, may have difficulty understanding computer-generated speech which might be provided with standard pronunciation. Such a user may be familiar with persons speaking in his/her own native pronunciation and might have difficulty understanding the audible output from the computer.

Likewise, users from non-English speaking countries who have learned English as a foreign language might have difficulty in listening comprehension of the English language due to inherent problems in understanding foreign speech. Part of the problem of sub-optimal listening comprehension might result from the unfamiliarity with the accent of native speakers. The present invention addresses this problem by providing a voice-recognition system in which the audible output speech is in the voice of the user. Thus, the user would have no problem in comprehending the output speech because the output speech is in the user's own voice.

Also, because the output speech is in the user's own voice, the user may not even be required to speak any particular language. For example, a user in the United States might not even be able to speak English. However, the non-English speaking user in the United States would still be able to use the present system effectively and efficiently and have no problems comprehending the audible output of the system. The system could easily adapt to any input speech pattern or any accent because the audible output from the computer would match the input voice (i.e., voice of the user).

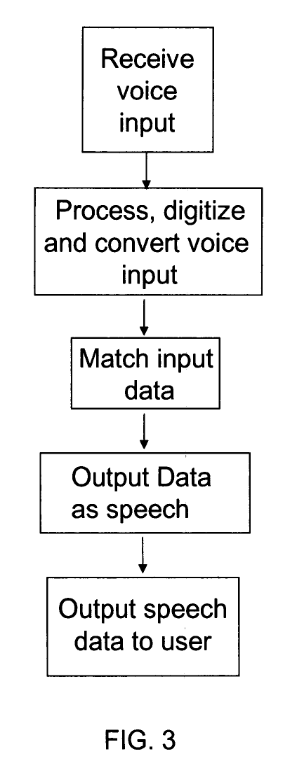

FIG. 3 illustrates an example of the operation of the system. A user provides voice input into the system. The voice input is identified by the system, processed, digitized and converted to data. The data may be stored in a database and matched to corresponding data. Desired data corresponding to the matched corresponding data may then be output as speech via a data output engine through an output device such as a headset or speaker.

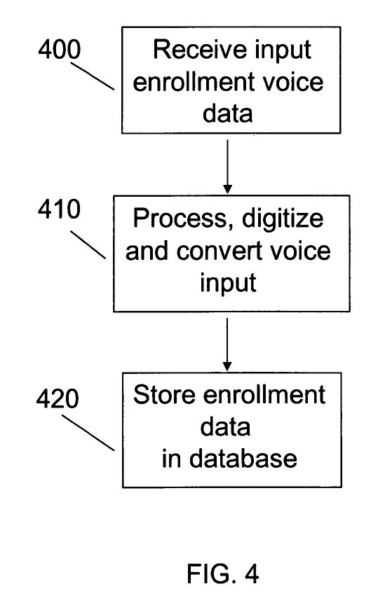

As FIG. 4 illustrates, a user may initially enroll in the system by executing a one-time set up procedure that trains the system to recognize the user's voice. Additionally, the enrollment process may be used to establish a unique user profile. For example, the user inputs enrollment data (step 400) which may include reading a predetermined passage into the input of the system to train the system to recognize the user's voice. The user may further be prompted, for example, to read numbers zero through nine, letters of the alphabet, the user's name, identification number or a password. The input information is processed and digitized (step 410) and stored in the database (step 420). The system receives the input speech (including words or phonemes) from the user, processes the input speech and may further store the processed data in the database in association with a user profile corresponding to the user. This process need not be repeated once the user profile is established.

The user may also initially set up a user id and password for secure login. By doing so, the user can ensure the security and integrity of the system. Also, the proper user profile corresponding to the particular user on the system may be selected. Thus, the system, having been trained to recognize the particular user as identified in the stored user profile, recognizes the input speech of the user. The system may further provide output data in the form of speech corresponding to the user's voice. For example, the system may construct output speech based on the words and/or phonemes input from the user and stored in memory during initial enrollment of the user.

Following one-time enrollment, the user may logon using any number of logon procedures. After logging on, the user may speak information into the system (e.g., via a microphone). The system recognizes and converts the input speech to data and obtains corresponding data from the database. The data thus obtained from the database is converted to speech data and output to the user (e.g., via a speaker or via headsets). The speech data output to the user may be in the same voice as the user.

The system and method of the present invention is particularly useful in situations where a user requires hands-free retrieval of data without the burden of distractions from the system itself. For example, one application of the present invention is sorting of mail in any mail facility such as the U.S. Postal Service.

The U.S. Postal Service delivers approximately 202 billion pieces of mail per year including letters, flats, spurs, and packages. This accounts for over 46% of the world's mail volume and covers a larger geographic area than any other country. Typically Optical Character Reading (OCR) technology provides approximately 95% accuracy in the sorting of mail within the Postal Service. However, even with this high accuracy rate, there is still approximately 5% of mail in which OCR fails. Because of the large overall volume of mail being handled, 5% of the mail still constitutes a large amount of mail. These mail items fail to obtain an accurate bar code and are sent to the local post offices (based on the zip code) for manual sorting (i.e., “manual mail”). Specially trained distribution clerks at the local post offices manually sort these mail items by assigning each item of mail to a corresponding letter carrier/route based on the street address.

The Post Office assigns large blocks of addresses to a “scheme”, each scheme describing a potentially large set of addresses within a designated area (e.g., over a thousand streets and associated carrier numbers) that belong to various carrier routes. One distribution clerk is assigned to one scheme for sorting mail; however, the current system is prone to errors because manual mail lacks a proper bar code and the distribution clerks must rely solely on memory of which address corresponds to which mail route within the scheme.

In a large metropolitan area, a single scheme may contain up to 2000 subsets of addresses thus necessitating costly, extensive and lengthy training of distribution clerks to allow the clerks to memorize each address grouping. The need for extensive prior training and memorization of schemes precludes the hiring of “casuals” (i.e., temporary workers) as needed to perform the mail sorting task. Moreover, if a clerk is unexpectedly unable to work on a given day (e.g., due to illness or other emergency), it is extremely problematic finding a replacement as there may be no other worker available at that time that has the training and knowledge of the schemes, addresses and corresponding carrier routes.

Even under the best of circumstances, trained clerks might still fail to remember a particular address/route assignment resulting in “mis-throws” (i.e., errors in mail sorting), misdirected/delayed mail, or “loop mail” (i.e., mail that is repeatedly misdirected in an infinite loop). This problem is compounded with uncommon addresses in which the clerk is more likely to forget the proper route. In addition, the clerk might not be informed as to the latest updates to addresses which could lead to increased numbers of “mis-throws”.

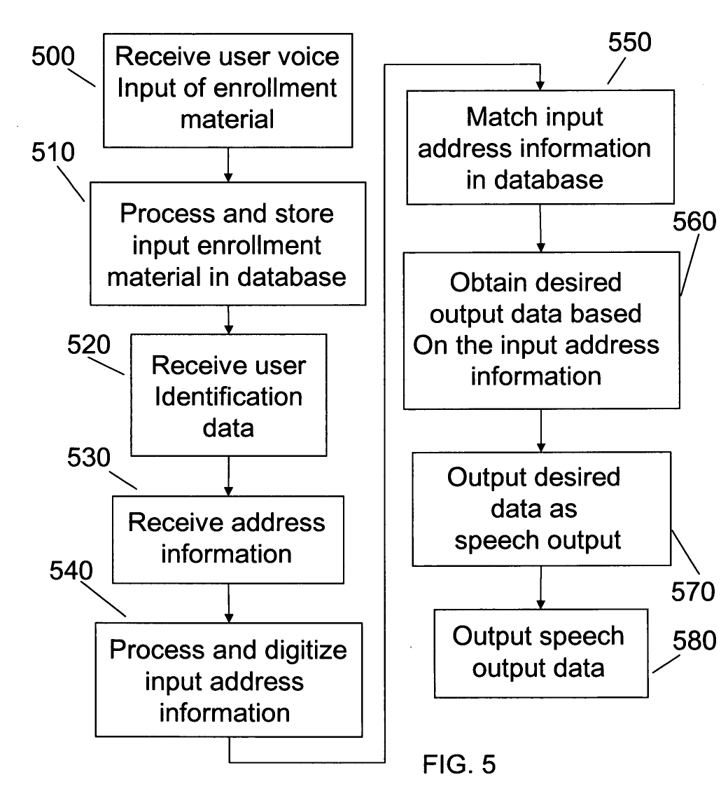

The present invention may be applied to the U.S. Postal Service as illustrated in FIG. 5 to provide a system in which the distribution clerk receives cues regarding the proper route number based on the address of any given manual mail. In addition, the cues may be audio cues from the system and may further be in the distribution clerk's own voice, thus ensuring full comprehension of the output by the distribution clerk. For example, a distribution clerk might be sorting a letter with a particular address, e.g., “123 Elm Street”, to assign the letter to the proper letter carrier route. In this example, “Elm Street” may be very long and/or have many house/building numbers and different ranges of house/building numbers may be assigned to different letter carrier routes. In addition, “Elm Street” may not be a commonly addressed street such that the clerk does not repeatedly encounter the street when sorting mail. For at least any of these reasons, the clerk might not clearly remember which route number corresponds to “123 Elm Street”.

As shown in FIG. 5, the clerk first logs into the system and trains the system to recognize his/her voice. The training process is a one-time set up procedure that need not be repeated once completed. To train the system, the system receives enrollment information (step 500) in which the clerk need only read predefined text into the system. The input speech and phonemes are received through the VUI, analyzed and processed through the SRE and stored in the database (step 510). Through this process, the system adjusts for the particular clerk's speech patterns and other speech characteristics and stores this information in the database associated with the clerk's personal profile. The predefined text that is read into the system may vary depending on local requirements or as the particular clerk's speech characteristics dictate. For example, in certain regions, certain words may be pronounced a certain special stylized way. If that is the case, the predefined text may contain instances of those words such that the system can be trained in these problem areas. In this way, the system may accommodate any special foreign or regional accents, speech impediments or other unique qualities of a particular clerk's voice/speech. Also, in the U.S. Postal Service example, numbers will most probably be needed. Thus, the user may read in all digits 0-9 into the system such that the system can be trained to recognize these words and phonemes and subsequently output the words to the user. Any other desired words or phonemes may be entered into the system as needed. The system may thereby be trained to recognize any speech patterns from a particular user, including any variations in pronunciation unique to that particular user. Additionally, the system may output data in the form of speech corresponding to the particular user's own voice. In this way, the user is most likely to easily understand the output from the system.

After the enrollment process is complete, the system may receive user identification data when the clerk logs onto the system (step 520). There are many effective ways of logging onto the system and any log on method may be used. For example, the system may require the clerk input a password through an input device, such as a keyboard, mouse, touchpad, monitor, or voice input in which the user may verbally state the proper password into a microphone or, alternatively, respond properly to a series of questions in a challenge response format. This latter technique is effective in preventing inadvertent theft of one's password since the questions are presented randomly.

During operation of the system in the U.S. Postal Service embodiment, the clerk reads an address into a microphone from a mail item (e.g., a letter, flat, spur or package) (step 530). The address may comprise a number and a street name (e.g., “123 Elm Street”). Alternatively, the address that is read into the system may also specify other information to increase the sensitivity and accuracy of the system. By including additional information in the voice input, the system may be capable of sorting mail over a wider geographic range, over multiple postal jurisdictions, or over multiple and complex postal schemes. For example, the clerk may include information such as the city, state or zip code. If the clerk specifies “123 Elm Street, Mytown, Pa.”, the system would be capable of differentiating “Elm Street” in a city other than “Mytown” or a state other than “Pennsylvania”. Likewise, if the clerk included the zip code, the system would be capable of differentiating between similar addresses in different zip code areas. Thus, any combination of address information may be input into the system.

The input speech (e.g., address information in the U.S. Postal example) from the clerk is input through the VUI 100 and processed and digitized in the SRE 110 (step 540). The address information is sent to the database where the address information is matched with a corresponding address in the database (step 550). The corresponding address in the database is associated with desired output data, in this case, a carrier route number (step 560). Presently, the carrier route number is typically a three-digit number assigned by the post office but the present invention is not limited as such. The application 120 and data output engine 140 outputs the carrier route number data as speech data. This may be accomplished in a variety of ways. For example, words or phonemes previously stored in the database by the user (step 570) may be assembled. The carrier route number is sent to the VUI 100 and may be delivered to the clerk through a speaker or headset (step 580). Additionally, the output may be in the clerk's voice (for example, created from previously input words and phonemes from the clerk) to ensure complete comprehension by the clerk.

The system as applied in the U.S. Postal System example further enables close monitoring and quality control of all aspects of the activity. Moreover, the monitoring or quality control may be accomplished remotely. In the current process of training of distribution clerks, there is no effective way of monitoring the training process. Without effective monitoring of training, there can be no assurance that the training process is effective or that the individual being trained is learning the skills being taught. With the system of the present invention, the training process may be easily and effectively monitored. Both the training process and the system itself may be monitored. Furthermore, the monitoring need not be performed at the site of the training. Information pertaining to the operation of the system, including training of users, may be wirelessly transmitted to a server and further transmitted to a remote site for further evaluation. This information may also be filtered (e.g., noise cancellation or selected frequency response) such that only certain designated information is transmitted while extraneous information is omitted. The information may further be compressed for higher throughput over a given bandwidth.

Additionally, the mail items may be presented to the clerk in a manner that optimizes visual clarity. By image capture, the mail items may be scanned such that images of the individual mail items are presented to the clerk. The mail items travel through the system while the clerk views the image presented by the system. The image presented may be manipulated in any number of ways by the clerk. For example, the clerk may increase or decrease the contrast, brightness, sharpness, resolution, image size, etc. In this way, mail items that are not easily read by the clerk may be manipulated such that they are easier to read with higher reliability.

Thus, after image capture of the mail items, the clerk views the image of the mail item, manipulates the image as necessary to increase clarity, and speaks input data (e.g., the address) from the mail item into the system. There are many methods in which the clarity of the image may be improved. For example, different light may be utilized to increase optical clarity—e.g., ultraviolet light or infrared light. The system then presents a speech output to user indicating the proper destination of the mail item based on the speech input data as set forth above. Alternatively, the system may send a command signal to direct the mail to the proper destination based on the voice input from the user. Image capture may be accomplished through a camera or scanning system in which the mail items are photographed, or electronically scanned into the system.

The present system may also be used in sorting mail in mailboxes, for example, post office boxes. Often mail customers who rent post office boxes have special requirements for the postal worker who places the mail in the individual post office boxes. For example, a mail customer renting a post office box may submit a temporary hold on the mail or a mail forwarding order. Because there are numerous post office boxes at each post office, the postal worker may have difficulty in remembering special mail handling procedures for any given post office box. Also, rent for the post office box may be overdue and therefore mail should be held or a note should be placed in the corresponding post office box reminding the customer to pay the rent. Any of these situations would require the postal worker to provide special services to the individual post office box. However, if the postal worker does not remember the specific required action for a post office box because, for example, there are too many post office boxes to remember, then the action will not be taken and there will be subsequent difficulty depending on the nature of the required action.

Following enrollment of the postal worker to use the system as set forth above, the present invention can be used in this example where the postal worker sorting mail into post office boxes can speak the box number into a microphone or headset during sorting of mail. Speech is input through the VUI 100 and processed and digitized in the SRE 110 in accordance with the application 120 where the speech is converted to data through speech recognition software. The data corresponding to the box number is then compared to matching data in the database 130. When a match is found, the corresponding instructions associated with the corresponding post office box number are processed and output as speech data via the application 120 and data output engine 140. The post office box number is then output through the VUI 100, such as a microphone or speaker to the postal worker. The speech output to the postal worker may be in the postal worker's voice to ensure optimal comprehension.

In another example, the system of the present invention may be used in product delivery. For example, a newspaper delivery person servicing a particular route must remember which residence receives a newspaper subscription (and therefore should receive a newspaper) and which residence does not. Typically, each individual customer may cancel newspaper delivery while new customers may request delivery service. Still other customers may temporarily suspend delivery of the newspaper for a specified period of them. Other customers may request delivery of the newspaper only on certain days of the week and not other days of the week. The delivery person must remember each of these orders while delivering the newspaper. At the same time, the delivery person must complete delivery rounds in a specified period of time such that the customers will not complain of late delivery of the newspaper.

However, the delivery person might not clearly remember every residence that is supposed to receive the newspaper on a given day. Even if only one customer does not receive the newspaper, that customer would complain and a copy would have to be specially delivered to that customer. Not only would the customer receive the newspaper very late, but also the delivery service would waste time and resources sending a delivery person back out to the neighborhood to deliver the few missed newspapers.

The present invention can solve problems such as this by providing a system and method in which the delivery person can speak the address of a residence into a microphone. The microphone may be connected to a headset, for example. Alternatively, the microphone may be a stand-alone microphone. For added convenience and portability, the microphone should be wireless. The input speech signal is received through the VUI 100 and processed and digitized in the SRE 110. The speech signal is converted to data which is then compared in the database 130 with a matching address. The matching address in the database 130 has associated information. In this example, the associated information may be whether the customer receives the newspaper or not, which days the customer receives the newspaper or if there is a stop delivery order on the newspaper, for example. Any desired information may be associated with the address in the database 130. The associated information is then output via the data output engine 140 to the delivery person via the VUI 100 in the form of speech. The speech output may be provided to the delivery person via any number of means, for example, a headset or speaker. Additionally, the speech output may be provided in the delivery person's voice to maximize comprehension.

In another example, a physician treating a patient may desire a complete differential diagnosis of a patient given the patient's specific signs and symptoms. The physician, after enrolling in the system and logging onto the system can speak a sign or symptom of the patient into a microphone that may be connected (e.g., wirelessly) to the system of the present invention. The SRE 110 converts the speech input to data and compares the data to matching data in the database 130. The matching data in the database is associated with desired information, for example, a differential diagnosis. To enhance the response of the system, the number of words or phonemes may be limited such that only associated code numbers (e.g., ICD codes) are stored in the database 130. The desired differential diagnosis information is then output in the form of speech through the data output engine 140 and delivered to the physician through the VUI 100. The output speech may be in the physician's voice to enhance comprehension.

In another example of the present invention, a system and method is provided to respond to a user's voice input by outputting a selected passage from a written document or volume. For example, a user may desire a selected chapter/verse from the Bible. The user speaks the desired chapter/verse identification into a microphone, for example. The user's voice input may be transmitted wirelessly to the system which may contain a solid state device (for example, an MP3 device or a memory card). The system may contain, for example, SRE 110 which converts the speech input to data and compares the data to matching data in the database 130. In this example, the data indicates the chapter/verse of the desired passage from the Bible. For example, pointers may be used in digitized format to point to the desired data in storage which is associated with the corresponding chapter/verse desired. Moreover, using compression technology, the output data may be compressed efficiently and economically onto a small number of data storage media.

The names of the individual books of the Bible are distinct as well as the numbers. The resultant limited input phonemes input into the system further enhances the specificity of the system. The desired passage may be output from the system through a speaker or headset to the user. Further, the user may request continuation of the reading into the next verse by speaking a command to continue the recitation. The system responds by continuing the recitation through the next verse or any other passage requested by the user.

In another example of the present invention, the system and method provides Theft of Identity Protection (TIP). In this embodiment, the system may provide protection against identity theft or credit card/identity fraud, for example. The system receives voice input from a user which may be keywords. The keywords may be randomly selected by the user or may be selected from a database of keywords from a database in the system. For example, in an initiation phase, the user may speak into a microphone or a headset by reading a series of randomly selected keywords. The system receives the speech signals from the user via an SRE 110. The speech signals are converted to data and stored in a database 130. The data is stored in the database 130 for use in identification of the user. When a user desires to perform a personal, secured task, such as accessing a bank account, making a credit card purchase, withdrawing money from an account, etc., the user may dial into the system. Typically the user may enter a password to identify him/herself. However, if the password is stolen by a third party, security is compromised.

To prevent unauthorized access to the account, unauthorized use of credit or any other type of similar fraud, the system may prompt the user to recite a random selection of keywords previously entered into the system and stored in the database 130. For example, a user may have stored fifty keywords in the database 130. The system will choose a subset of the fifty keywords from the database 130 in random order and instruct the user to recite the keywords in order. The user repeats the keywords as instructed. The system compares the input speech and matches the speech with the stored speech to ensure proper identification of the user. If a match is not found, then the caller is not permitted access to the personal information. Only when a voice match is found after voice recognition is performed can access be granted.

A thief might attempt to record the individual words from the user to bypass the security system. However, by choosing a random order, the thief would be unable to accurately predict the order in which the computer will request the information. For example, the thief might have a recording of the keywords on a tape but could not find a particular word within a predetermined length of time after requested to produce the keyword by the system.

Alternatively, in the Theft of Identity Protection (TIP) embodiment, the system may request answers to a series of security questions to provide an added layer of security. In this embodiment, the user must not only answer the questions with the correct answers but must also provide the answers in the proper order. For example, the system may ask the user for his/her mother's maiden name, the name of his pet, the name of his kindergarten and his favorite beverage. The user would then answer the questions in order by stating the answers verbally into the system. The system recognizes the user's voice by matching the voice to the stored responses in the database. If a match of the voice, answers and order of answers is detected, the user has passed the security screen.

The Theft of Identity Protection (TIP) embodiment may also be applied to transactions made on the Internet. For such online transactions, such as purchasing goods at a website, banking online, etc., the user may first call the system on the telephone to obtain a security code. For example, as set forth above, the user may recite keywords in the order requested by the system. The system matches the input keywords with the user's keywords. If the voice matches, then the user is given a security code number which may be used to complete the online transaction desired.

The voice recognition system is disclosed as theft identity protection but is not so limited. The system may be utilized whenever identification of a user is desired. For example, when a physician calls a prescription into a pharmacy for a patient, the pharmacist may not know the identity of the caller. If a drug-seeking patient, for example, calls into the pharmacy masquerading as the physician and authorizing various drugs, the pharmacist might not know that it is not the physician calling. Similarly, anyone might call into the pharmacy making bogus claims, thus compromising the system. In the present invention, a physician calling a valid prescription into a pharmacy is confirmed through voice recognition as described. Alternatively, the voice recognition system may be used to verify the identity of individuals in product shipment, inventory or warehousing in which authorized individuals may order that action be taken (e.g., a warehouse manager shipping a product). The system confirms the authorized individual through voice recognition.

The present invention relates to a system and method for speech recognition that receives speech input and converts the speech input to data. A database is accessed to determine stored data corresponding to the speech input data. The stored data is associated with desired output data. The output data is output to a user as speech output. The speech output data may be in the same voice as the user to enhance comprehension and clarity. The present invention may be used in sorting mail in which a street address or post office box number is spoken into the system and the system provides desired information in the form of speech. The desired information may include carrier route number, mail-forwarding information, mail hold information or fee payment information but is not so limited. The present invention may also be used to provide excerpts of written material to a user on command, such as a desired chapter/verse of the Bible.

It is understood that the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

1. A method of voice recognition of a user for sorting mail items, the method comprising:
receiving a first voice input of the user, said first voice input comprising a limited grammar corresponding to address information;
converting said first voice input into a first data;
identifying a second data in a database based on said first data, said second data being associated with said first data;
assembling output information from stored data based on said second data, said stored data being derived from voice input from the user;
converting the assembled output information corresponding to said second data into an audible output corresponding to the voice of the user.

2. The method of claim 1 further comprising receiving a third voice input of the user prior to receiving the first voice input of the user wherein said stored data is derived from said third voice input of the user

3. The method of claim 2 wherein the third voice input comprises digits.

4. The method of claim 1 wherein the first voice input comprises a predetermined set of phonemes.

5. The method of claim 1 wherein the first voice input comprises at least one of a destination street address or a destination post office box number of a mail item.

6. The method of claim 1 wherein the second data comprises information on the destination of a mail item.

7. A system of voice recognition of a user for sorting mail items, said system comprising:
a voice user interface for receiving a first voice input said first voice input comprising a limited grammar corresponding to address information;
a speech recognition engine for converting said first voice input into a first data;
an application unit for identifying second data based on said first data, said second data comprising output information associated with said first data, said output information being assembled from data stored in said database, the data stored in said database being derived from voice input from the user;
a text-to-speech engine for converting the assembled data corresponding to said second data into an audible output corresponding to the voice of the user.

8. The system of claim 7 wherein the voice user interface further receives a third voice input of the user prior to receiving the first voice input of the user wherein said data stored in said database is derived from said third voice input of the user.

9. The system of claim 8 wherein the third voice input comprises digits.

10. The system of claim 7 wherein the first voice input comprises a predetermined set of phonemes.

11. The system of claim 7 wherein the first voice input comprises at least one of a destination street address or a destination post office box number of a mail item.

12. The system of claim 7 wherein the second data comprises information on the destination of a mail item.

13. A computer readable medium comprising executable code for performing the steps of:
receiving a first voice input of the user, said first voice input comprising a limited grammar corresponding to address information;
converting said first voice input into a first data;
identifying a second data in a database based on said first data, said second data being associated with said first data;
assembling output information from stored data based on said second data, said stored data being derived from voice input from the user;
converting the assembled output information corresponding to said second data into an audible output corresponding to the voice of the user.

14. The computer readable medium of claim 13 further comprising receiving a third voice input of the user prior to receiving the first voice input of the user wherein said stored data is derived from said third voice input of the user.

15. The computer readable medium of claim 14 wherein the third voice input comprises digits.

16. The computer readable medium of claim 13 wherein the first voice input comprises a predetermined set of phonemes.

17. The computer readable medium of claim 13 wherein the first voice input comprises at least one of a destination street address or a destination post office box number of a mail item.

18. The computer readable medium of claim 13 wherein the second data comprises information on the destination of a mail item.

19. A method of voice-recognition for providing information from a database, said method comprising:
receiving a first voice input from a user;
parsing the first voice input into phonemes;
storing said phonemes in a database;
receiving a second voice input from said user and converting the second voice input into first data;
locating second data in memory corresponding to said first data;
converting said second data into a speech signal, said speech signal comprising words assembled from said phonemes stored in said database;
outputting said speech signal as voice output.

20. The method of claim 19 wherein said first voice input comprises predetermined text.

21. The method of claim 19 wherein said first data comprises at least one of a street address or a post office box number.

22. The method of claim 21 wherein said first data comprises a street address and said second data comprises destination information, said destination information corresponding to said street address.

23. The method of claim 21 wherein said first data further comprises an element selected from the group consisting of a name of a city, a name of a state, and a zip code.

24. The method of claim 21 wherein said voice output is in the same voice as said second voice input.

25. A system of voice-recognition for providing information from a database, said system comprising:
a voice user interface for receiving a first voice input and a second voice input from a user;
a processor for parsing the first voice input into phonemes and storing said phonemes in a database and converting said second voice input into first data;
a program for locating second data in memory corresponding to said first data;
a processor for assembling said phonemes stored in said database into a speech signal based on said second data;
an output for outputting said speech signal as voice output.

26. The system of claim 25 wherein said first voice input comprises predetermined text.

27. The system of claim 25 wherein said first data comprises at least one of a street address or a post office box number.

28. The system of claim 27 wherein said first data comprises a street address and said second data comprises destination information, said destination information corresponding to said street address.

29. The system of claim 27 wherein said first data further comprises an element selected from the group consisting of a name of a city, a name of a state, and a zip code.

30. The system of claim 25 wherein said voice output is in the same voice as said second voice input.
